(19) United States
(12) Patent Application Publication
(10) Pub. No.: US 2012/0327330 A1
(43) Pub. Date: Dec. 27, 2012

(54) LIGHTING DEVICE AND LIQUID-CRYSTAL DISPLAY DEVICE WITH THE SAME

(76) Inventors: Ken TAKAHASHI, Kumagaya-shi (JP); Osamu Ono, Fukaya-shi (JP); Hidemi Matsuda, Toda-shi (JP); Masahiro Yokota, Fukaya-shi (JP); Shusuke Morita, Fukaya-shi (JP); Nobuo Kawamura, Kumagaya-shi (JP); Takeshi Ookawa, Kumagaya-shi (JP); Takashi Nishimura, Fukaya-shi (JP)

(21) Appl. No.: 13/601,620

(22) Filed: Aug. 31, 2012

Related U.S. Application Data
(63) Continuation of application No. PCT/JP11/54788, filed on Mar. 2, 2011.

(30) Foreign Application Priority Data
Mar. 3, 2010 (JP) 2010-047018

(51) Int. Cl. G02F 1/13357; F21V 13/02; F21V 7/00

(52) U.S. Cl. 349/61; 362/296.01; 362/235

(57) ABSTRACT

According to one embodiment, a lighting device includes a light source, and a semi-transmissive reflection layer opposing the light source. The semi-transmissive reflection layer includes a pattern including transmitting portions or reflecting portions. The pattern includes a pattern formed of the transmitting portions each having a hole conformation in a region to which a high volume of light form the light source incident, and a pattern formed of the reflection portions each having a dot conformation in a region to which a low volume of light form the light source incident.

### CROSS-REFERENCE TO RELATED APPLICATIONS

This application is a Continuation Application of PCT Application No. PCT/JP2011/054788, filed Mar. 2, 2011 and based upon and claiming the benefit of priority from Japanese Patent Application No. 2010-047018, filed Mar. 3, 2010, the entire contents of all of which are incorporated herein by reference.

### FIELD

Embodiments described herein relate generally to a lighting device including a light source and to a liquid crystal display device with the lighting device.

### BACKGROUND

In recent years, with an increase in adoption of an LED (light-emitting diode) light source in interior and exterior illumination or backlights of trade signs, there has been required a lighting device which converts light from a point light source into a planar light source and has a reduced thickness and high light utilization efficiency.

Further, when a lighting device having a partial drive function is used as a backlight of a liquid crystal display device, it is possible to provide the liquid crystal display device that can achieve both energy saving and a high contrast ratio. As a lighting device that can achieve such performance, there has been proposed a backlight system in which many light guide plates and many light sources are aligned within a plane. Furthermore, there has been disclosed a technology that provides dot-like light attenuating means on a surface of the light guide plate in accordance with a distance from a light source to enable uniform illumination. There has been disclosed a technology that scatters micro-reflecting portions on a surface of a diffusion layer in a direct type backlight configuration, thereby enabling uniform illumination.

However, in the backlight system in which many light guide plates and many light sources are aligned within the plane, lights from light sources are attenuated while propagating through the light guide plates, and the light utilization efficiency is poor. Moreover, a process of installing the individual light guide plates and light sources with high positional accuracy is complicated, and manufacture is difficult.

The backlight having the dot-like light attenuating means does not have a configuration having a diffusing function behind the light attenuating means, and a resolution with which a dot-like pattern cannot be visually confirmed is required. On the other hand, in a generalized process, achieving the above-described resolution is difficult.

Additionally, since the direct type backlight has the same problems as those described above and it is formed below a diffuser panel, even if a pattern of a size that can be formed in a generalized process is adopted, when using a thinner diffuser panel is tried, the pattern is visually confirmed through the diffuser panel. Since a diffusion layer having a reflecting portions provided thereon is apart from a light source, in case of seeing from an oblique direction, there is a problem that unevenness in luminance occurs when positions of the light source and the reflecting portions deviate.

### BRIEF DESCRIPTION OF THE DRAWINGS

FIG. 1 is a sectional view of a lighting device according to a first embodiment;

FIG. 2 is a graph showing actual measured values when a dimension DL/PL in the lighting device is changed;

FIG. 3 is an enlarged plan view showing an aperture pattern of a semi-transmissive reflection layer of the lighting device;

FIG. 4 is an enlarged plan view showing an aperture pattern of another semi-transmissive reflection layer of the lighting device;

FIG. 5 is an enlarged plan view showing an aperture pattern of still another semi-transmissive reflection layer of the lighting device;

FIG. 6 is an enlarged plan view showing an aperture pattern of yet another semi-transmissive reflection layer of the lighting device;

FIG. 7 is an enlarged plan view showing an aperture pattern of a further semi-transmissive reflection layer of the lighting device;

FIG. 8 is an enlarged plan view showing a formation pattern of a still further semi-transmissive reflection layer of the lighting device, which is a formation pattern changed from a region having a low aperture ratio of the transmissive reflection layer to a region having a high aperture ratio of the same;

FIG. 9 is a plan view showing a formation pattern of another semi-transmissive reflection layer of the lighting device, which is a formation pattern as a rhombus-shaped arrangement pattern;

FIG. 10 is a plan view showing a formation pattern of still another semi-transmissive reflection layer of the lighting device;

FIG. 11A is a plan view showing unevenness in luminance of a pattern pitch when a dimension D in the lighting device is 0;

FIG. 11B is a plan view showing unevenness in luminance of a pattern pitch when the dimension D in the lighting device is 3 mm;

FIG. 12 is a graph showing a design aperture ratio (abscissa) of a semi-transmissive reflection layer in a hole conformation for each pattern pitch P and a standard deviation (ordinate) of a formation aperture ratio based on screen printing;

FIG. 13 is an exploded perspective view showing a liquid crystal display device including the lighting device according to the embodiment; and

FIG. 14 is a plan view schematically showing a light source arrangement in a lighting device according to another embodiment.

### DETAILED DESCRIPTION

In general, according to one embodiment, a lighting device comprises a light source; and a semi-transmissive reflection layer opposing the light source. The semi-transmissive reflection layer comprises a pattern comprising transmitting portions or reflecting portions. The pattern comprises a pattern formed of the transmitting portions each having a hole conformation in a region to which a high volume of light form the light source incident, and a pattern formed of the reflection portions each having a dot conformation in a region to which a low volume of light form the light source incident.

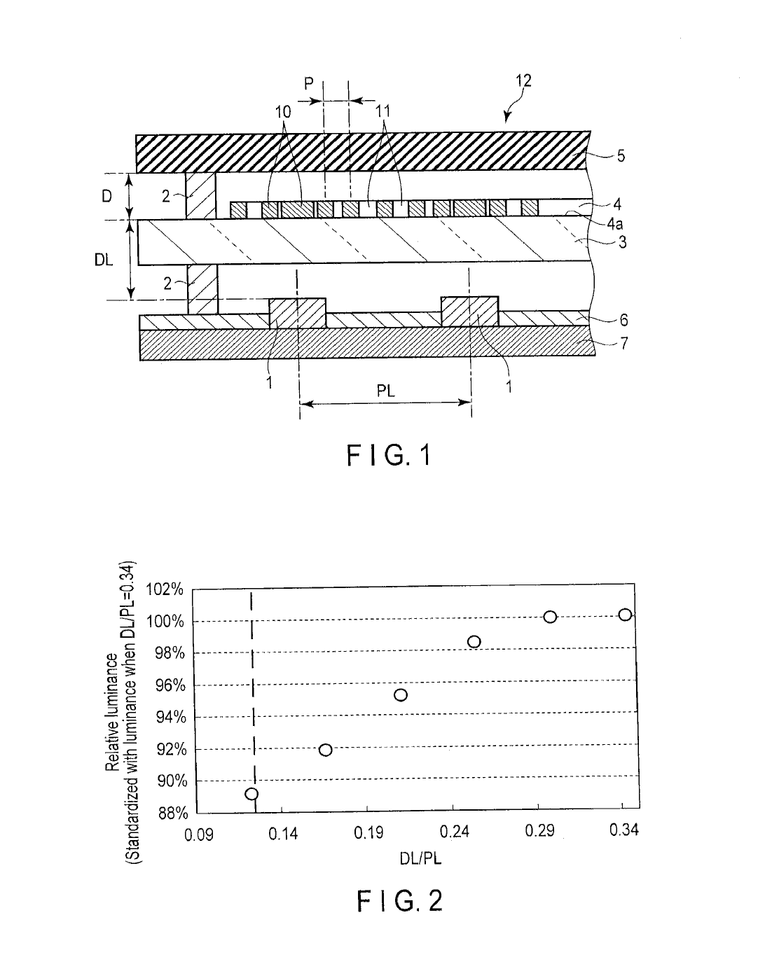

A lighting device according to an embodiment of the present invention will now be described hereinafter in detail with reference to the accompanying drawings. FIG. 1 is a cross-sectional view of a lighting device according to an embodiment of the present invention. As shown in FIG. 1, a lighting device 12 comprises a mount substrate 7 having, for example, a rectangular shape, a lower-surface reflection layer 6 that is formed on an upper surface of this mount substrate 7 and diffuses and reflects light, many point light sources 1 mounted on the mount substrate 7 through the lower-surface reflection layer 6, a light guide plate 3 that is arranged above the point light sources 1, faces the lower reflection surface 6, and has, for example, a rectangular shape, a diffuser sheet or a diffuser panel 5 that is arranged to face the light guide plate 3 with a gap therebetween and has, for example, a rectangular shape, and a semi-transmissive reflection layer 4 that is arranged between the light guide plate 3 and the diffuser panel 5.

Many point light sources 1 each of which is constituted of an LED are arranged on an entire surface of the mount substrate 7 with a predetermined alignment pitch in a matrix manner, and they are electrically connected with the mount substrate 7. A peripheral edge portion of the light guide plate 3 is supported on the mount substrate 7 by a support member 2, and the light guide plate 3 faces the lower-surface reflection layer 6 with a predetermined gap therebetween. A peripheral edge portion of the diffuser panel 5 is supported on the light guide plate 3 by the support member 2, and it faces a light extraction surface 4a of the light guide plate with a predetermined gap D therebetween. The semi-transmissive reflection layer 4 is provided over a part or all of the light extraction surface 4a of the light guide plate 3, i.e., a surface facing the diffuser panel 5.

The semi-transmissive reflection layer 4 is made of a material that transmits a part of light therethrough and reflects a part of the light. Lights emitted from the point light sources 1 enter the light guide plate 3, are propagated through the light guide plate 3, and then reach the semi-transmissive reflection layer 4 from the light extraction surface 4a of the light guide plate 3. A part of the light is transmitted through transmitting portions of the semi-transmissive reflection layer 4 and travels toward the diffuser panel 5 side, and a part of the lights is reflected by the reflecting portion of the semi-transmissive reflection layer 4 and then again propagates through the light guide plate 3. Although the light that returns from the light guide plate 3 to the point light source 1 side is partially generated, this light is reflected by the lower-surface reflection layer 6 and again returned to the light guide plate 3. With this process, the dispersion of the light advances, and the light exiting the diffuser sheet or the diffuser panel 5 can eventually achieve uniform luminance.

Usually, the light emitted from each of the point light sources such as LEDs becomes maximum in a portion immediately above the light source (central portion), and light distribution characteristics take a distribution of 100 to 160 degrees in terms of a full-width at half maximum. Therefore, reflectance of the semi-transmissive reflection layer 4 in the portion immediately above the light source must be increased, and a transmitted light volume of the same must be reduced. On the other hand, a degree of difficulty of diffusing the light to achieve uniform luminance is increased as an interval PL between the point light sources is widened. When the reflectance of the portion immediately above the light source is increased to facilitate the diffusion, a ratio of the light that again enters the point light source 1 is increased, and overall light utilization efficiency is deteriorated. When a distance DL between the semi-transmissive reflection layer 4 and the light extraction surface (exit surface) of each point light source 1 is configured to meet a relationship of PL<8×DL with respect to the arrangement interval PL, both the luminance uniformity and the light extraction efficiency can be achieved.

FIG. 2 is a graph showing actual measured values of average luminance of the lighting device when the distance DL between the semi-transmissive reflection layer 4 and the light extraction surface (the exit surface) of the point light source 1 is changed. In FIG. 2, an abscissa represents DL/PL, and an ordinate represents relative luminance standardized with luminance when DL/PL=0.34 mm. In this embodiment, the point light sources 1 are arranged in a reticular pattern, and their arrangement interval PL is set to, for example, 15 mm. The interval DL between the light extraction surface of the point light source 1 and the semi-transmissive reflection layer 4 is set to, for example, 3 mm. Consequently, as shown in FIG. 2, the efficiency (the relative luminance) that is not lower than 94% is assured. As can be understood from FIG. 2, in order to assure the efficiency that is not lower than 90%, it is desirable to set DP to be larger than ⅛×PL.

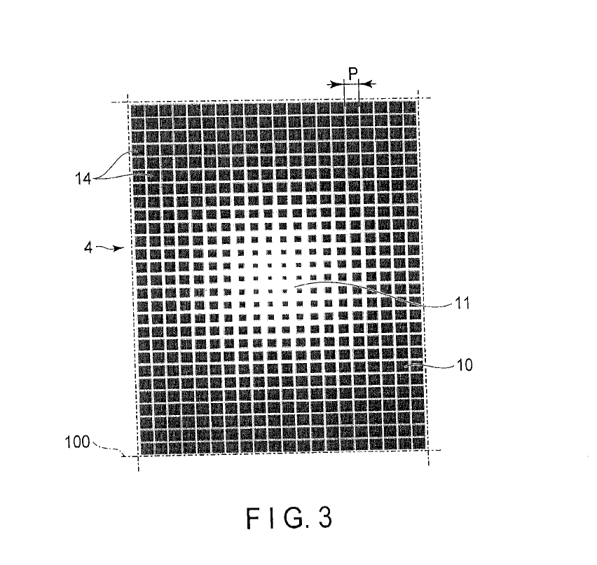

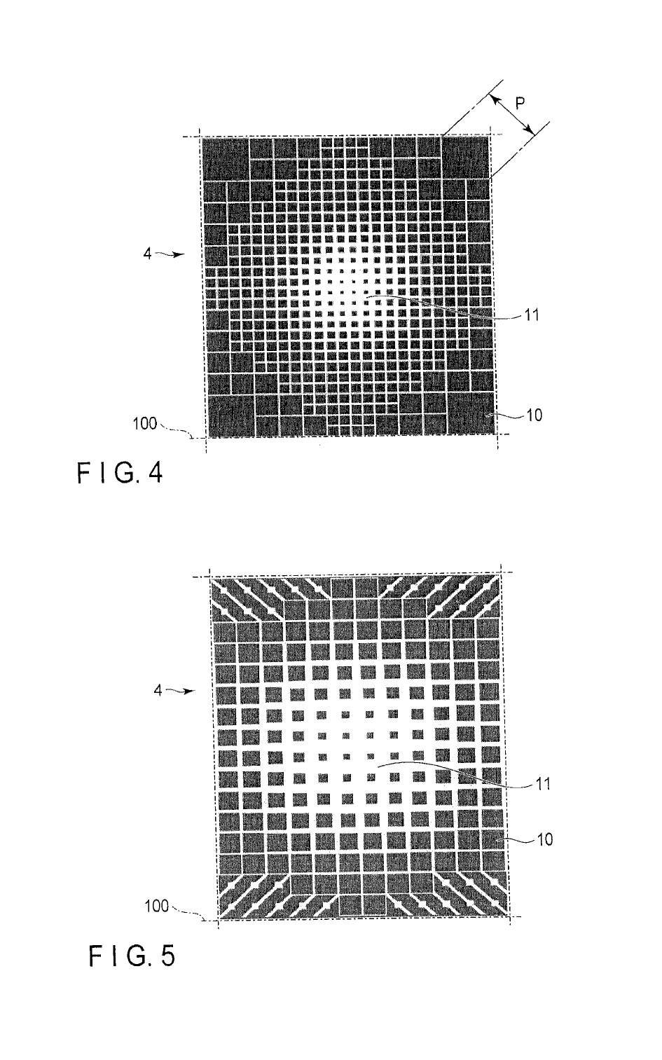

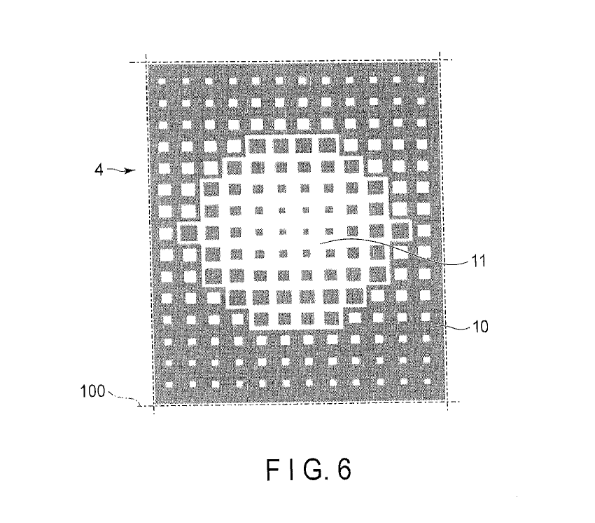

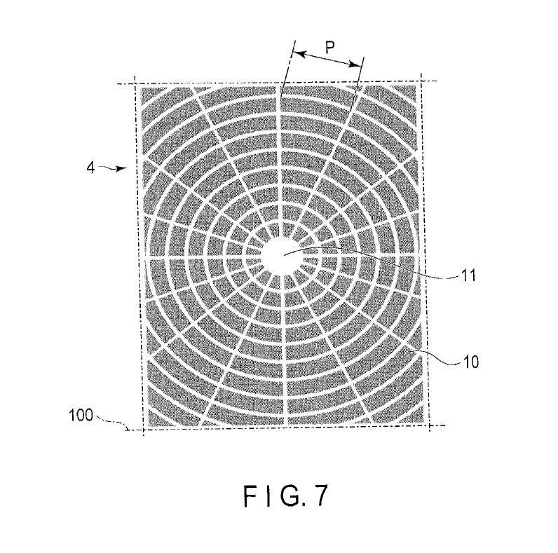

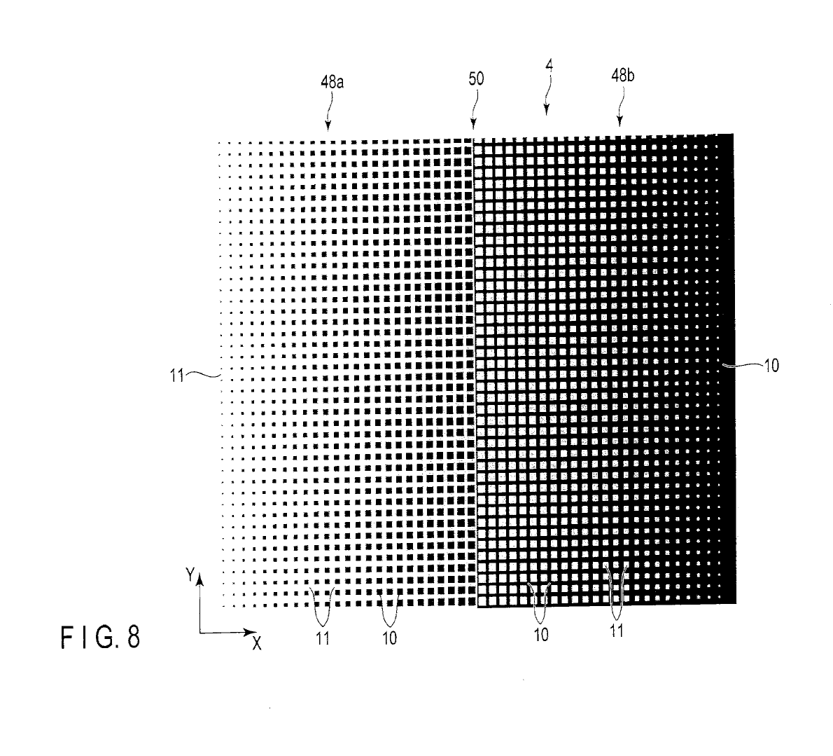

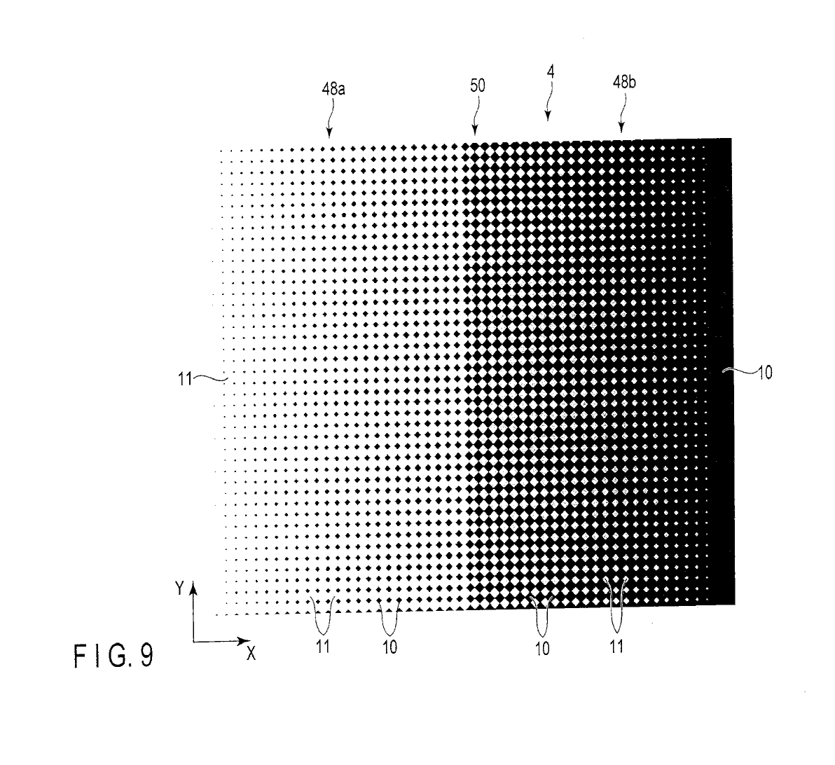

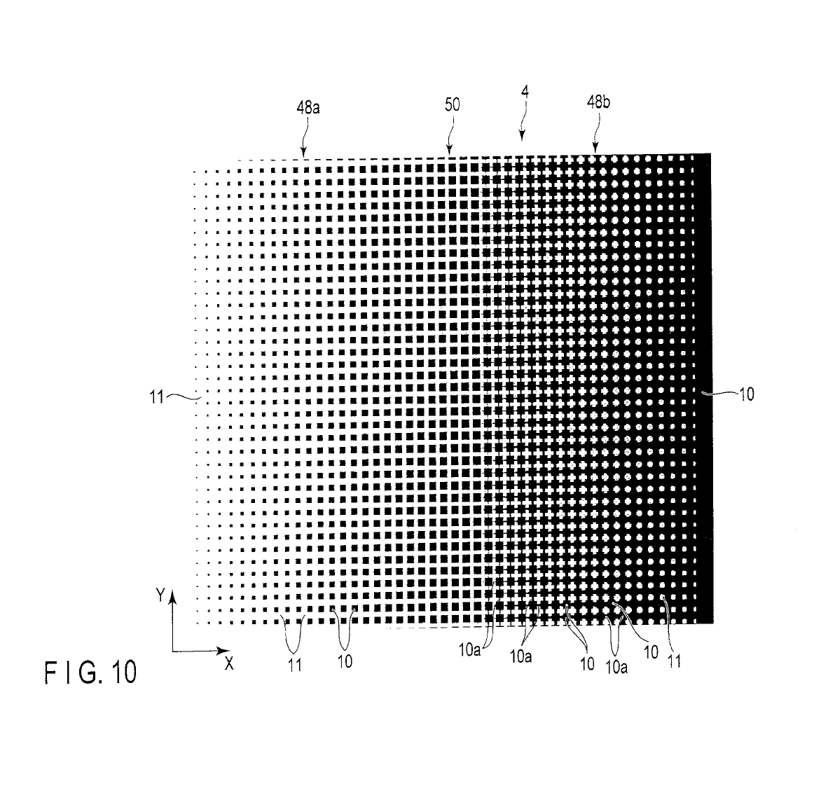

FIG. 3, FIG. 4, FIG. 5, FIG. 6, FIG. 7, FIG. 8, FIG. 9, and FIG. 10 are plan views showing aperture patterns of the semi-transmissive reflection layers 4 according to various embodiments in an enlarging manner, respectively. A region 100 having a cycle period of the semi-transmissive reflection layer 4 is determined in accordance with a two-dimensional arrangement of the point light sources 1, and the point light source is arranged at a position facing the center of this region 100. For example, in the first embodiment shown in FIG. 3, in each region 100 of the semi-transmissive reflection layer 4, transmitting portions 10 that transmit light therethrough are formed, and reflecting portions 11 that reflect 60% or more of the light and transmits 40% or below of the light are formed at positions where the transmitting portions 10 are not formed. In FIG. 3, each black part represents a transmitting hole which constitutes the transmitting portion 10, and each white part represents the reflecting portion 11. That is, in this embodiment, a hole type semi-transmissive reflection layer 4 is configured, and the transmitting portions 10 are patterned in the reflecting portion 11 at uniform intervals. As a result, the semi-transmissive reflection layer 4 transmits a part of the light therethrough, reflects a part of the light, and forms a uniform luminance distribution. That is, the pattern constituted of the transmitting portions 10 or the reflecting portion 11 is formed by combining continuous pattern groups having fixed pattern intervals, and an aperture ratio distribution of each pattern group is individually controlled by changing a size of the transmitting portion or the reflecting portion in accordance with a forming position Alternatively, the pattern constituted of the transmitting portions and the reflecting portion may be formed by combining continuous pattern groups having different pattern intervals.

As shown in FIG. 1 and FIG. 3, in the first embodiment, each transmitting portion 10 of the semi-transmissive reflection layer 4 is formed of, for example, a rectangular transmitting hole, and a hole diameter of the transmitting portion 10 in a portion above the point light source 1 (central portion) is formed smaller than that in a portion apart from the point light source 1 (end portion). Further, as compared with the portion apart from the point light source 1 (the end portion), the transmitting portions 10 in the portion above the point light source 1 (the central portion) are formed to have wider formation intervals. As a result, the semi-transmissive reflection layer 4 is adjusted in such a manner that this layer can strongly reflect the intensive light in the portion directly above the point light source 1 (the central portion) and obtain the uniformity of luminance of the lighting device 12 as a whole.

As shown in FIG. 1, the diffuser sheet or the diffuser panel 5 is arranged in such a manner that the interval D between itself and the semi-transmissive reflection layer 4 becomes larger than the uniform pattern interval P of the semi-transmissive reflection layer 4. That is, assuming that D is the interval between the semi-transmissive reflection layer 4 and the diffusion layer (the diffuser panel 5) which is the farthest from each light source 1 and P is the maximum arrangement interval P in the pattern at which the transmitting portions or the reflecting portions are adjacent to each other in the semi-transmissive reflection layer 4 which is the farthest from the light source 1, the lighting device 12 is configured to meet a relationship of D P. In the embodiment, D=3 mm and P=1.2 mm are set. When a position of the diffuser panel 5 is close to the semi-transmissive reflection layer 4, the individual aperture patterns of the semi-transmissive reflection layer 4 are not dispersed in a luminance distribution on the light extraction surface of the diffuser panel 5, thereby resulting in unevenness in luminance.

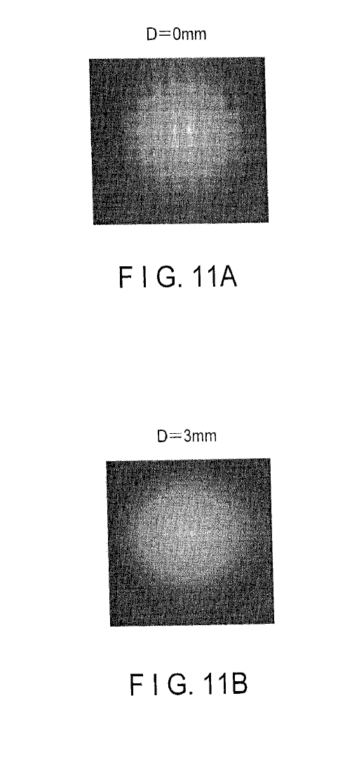

Each of FIG. 11A and FIG. 11B is a view showing unevenness in luminance of the pattern pitch of the semi-transmissive reflection layer 4 when the interval D is changed. Here, values obtained by actually measuring unevenness in luminance using the thin diffuser panel 5 having a thickness of 0.2 mm are shown. As compared with a case where the interval D is small, for example, D=0 mm as depicted in FIG. 11A, when the interval D is increased (for example, 3 mm) as shown in FIG. 11B, light rays emitted from the transmitting portions 10 spread to the periphery with the interval D and mix with light rays emitted from the adjacent transmitting portions 10, whereby the unevenness in pattern pitch is eliminated. A threshold value in this example is DIP=1, and the unevenness in pattern pitch cannot be visually confirmed by the diffuser panel 5 when the D is set larger than this threshold value. It is to be noted that the same unevenness improving effect can be obtained by reducing or increasing the transmittance of the diffuser panel 5, but a light ray component to be reflected and absorbed is increased to deteriorate the efficiency or a resin material amount cost or a weight is increased at the same time. Therefore, it is desirable to increase the interval D and thereby eliminate the unevenness in pattern pitch.

As can be understood from FIG. 3, the aperture ratio of the semi-transmissive reflection layer 4 is set low in the portion immediately above each point light source 1 and high in the peripheral portion. In the first embodiment, a minimum aperture ratio is 10% and a maximum aperture ratio is 70% with respect to a pattern pitch P of 1.2 mm.

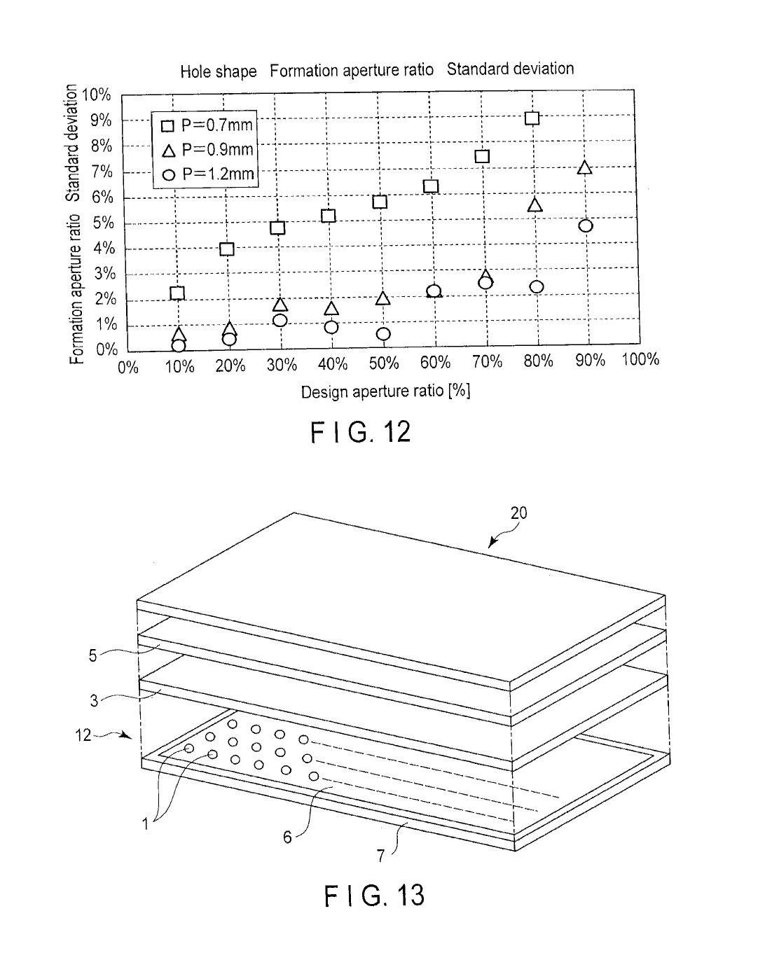

FIG. 12 is a graph showing a design aperture ratio (abscissa) of the semi-transmissive reflection layer 4 in a hole conformation for each pattern pitch P and a standard deviation (unevenness) (ordinate) of the aperture ratio of the semi-transmissive reflection layer 4 formed based on screen printing. It can be understood from FIG. 12 that the unevenness in aperture ratio due to a manufacturing process is increased in a region with a high aperture ratio and the unevenness is prominent with a narrow pattern pitch P in particular. That is because the unevenness in aperture ratio is dependent upon a line width to be patterned. That is, in the semi-transmissive reflection layer 4 having the hole conformation, in a region with the highest aperture ratio that faces a space between the light sources, a width of the reflecting portion 11 is narrowed, and the unevenness due to the manufacturing process tends to occur. In the embodiment, these matters are taken into consideration, the pattern pitch P is set to 1.2 mm, and the maximum aperture ratio is set to 70%. Furthermore, at the same time, the interval D is set to 3 mm, and a design is made so that the unevenness in pattern pitch cannot be visually confirmed.

An aperture shape of each transmitting hole of the semi-transmissive reflection layer 4 is not restricted to a square shape depicted in FIG. 3, any other shape such as a triangular shape or an elliptical shape can be adopted, and a shape can be appropriately selected while considering formation stability and others in an existing pattern formation process of existing screen printing and the like.

FIG. 4 shows an aperture pattern of a semi-transmissive reflection layer 4 according to a second embodiment. Although the aperture pattern is the same hole conformation as that depicted in FIG. 3, a pattern pitch P is set high at a position which is far from each point light source 1 and where a pattern with a high aperture ratio is formed and, in contrast, the pattern pitch P is reduced at a position close to the point light source 1 since a design aperture ratio precipitously varies at each forming position so that an aperture ratio distribution can be precisely controlled, thereby obtaining the design that characteristics are hardly affected by unevenness in printing even in a region with high aperture ratio where unevenness is prominent as shown in FIG. 12.

FIG. 5 shows an aperture pattern of a semi-transmissive reflection layer 4 according to a third embodiment. The third embodiment corresponds to a modification of the second embodiment, and a lattice-like pattern arrangement is broken at an outer peripheral portion of a region 100, and an aperture pattern P of transmitting portions 10 is changed.

FIG. 6 shows an aperture pattern of a semi-transmissive reflection layer 4 according to a fourth embodiment. According to this embodiment, in a region 100, a central region close to a point light source 1 has a hole conformation, and an outer peripheral region far from the point light source has a dot conformation. As described above, unevenness occurs in a portion with a high aperture ratio in the hole conformation, and unevenness is deteriorated in a portion with a low aperture ratio in the dot conformation. Therefore, as shown in FIG. 6, the hole conformation and the dot conformation are properly used depending on an aperture ratio, and an aperture pattern is formed. That is, an aperture pattern in a central region with a low aperture ratio has a hole conformation, and an aperture pattern in a peripheral edge region with a high aperture ratio has a dot conformation. As a result, unevenness in the region with a high aperture ratio in the dot conformation shown in FIG. 12 can be avoided, unevenness in the region with a low aperture ratio in the hole conformation (the unevenness is increased in the region with a low aperture ratio in the hole conformation because of the same process) can be avoided, and unevenness caused by a formation process can be reduced. Additionally, as shown in the drawing, an aperture pattern distribution does not have to be symmetrical with a portion immediately above the light source at the center, and an optimum distribution can be appropriately taken in accordance with a luminous intensity distribution of the light source.

FIG. 7 shows an aperture pattern of a semi-transmissive reflection layer 4 according to a fifth embodiment. According to this embodiment, an aperture pattern of the semi-transmissive reflection layer 4 has a polar coordinate system, and pattern intervals in a radial direction are equal intervals. Moreover, pattern intervals in a circumferential direction have regions which have an aperture ratio of 50% or above and formed at substantially fixed angles. In a point light source such as an LED, a light volume that enters the semi-transmissive reflection layer 4 from the light source can be written as a function of a radius with a portion immediately above the light source at the center and a deflection angle. The aperture pattern having an aperture ratio distribution adapted for a light volume distribution entering the semi-transmissive reflection layer 4 can be formed while considering limitations of a resolution in an existing pattern formation process of screen printing and the like. As a result, in the region 100 of the semi-transmissive reflection layer 4, a pattern pitch P in a circumferential direction is set higher in an outer peripheral region, which requires a high aperture ratio, apart from the light source, and an aperture pattern having symmetry properties is provided.

FIG. 8 shows an aperture pattern of a semi-transmissive reflection layer 4 according to a sixth embodiment. The sixth embodiment corresponds to a modification of the fourth embodiment and, in an aperture pattern of the semi-transmissive reflection layer 4, i.e., a formation pattern, a region close to a light source has a hole conformation and an outer region apart from the point light source has a dot conformation. As shown in FIG. 8, the aperture pattern of the semi-transmissive reflection layer 4 has a first direction X and a second direction Y orthogonal to this first direction X, and it is a pattern that varies from a region with a low aperture ratio (0%) to a region with a high aperture ratio (100%) along the first direction. A left end in the drawing corresponds to an aperture ratio 0%, and a right end in the same corresponds to an aperture ratio 100%. In the semi-transmissive reflection layer 4, transmitting portions 10 that transmit light therethrough are formed, and a reflecting portion 11 that reflects 60% or more of the light and transmits 40% or below of the light therethrough is formed in a part where the transmitting portions 10 are not formed. That is, in this embodiment, the hole type semi-transmissive reflection layer 4 is constituted, and the transmitting portions 10 are patterned in the reflecting portion 11 at uniform intervals. As a result, the semi-transmissive reflection layer 4 transmits a part of the light therethrough, reflects a part of the light, and forms a desired luminous intensity distribution.

In a region 48a with a low transmittance of the semi-transmissive reflection layer 4, the reflecting portion 11 has an integral pattern shape having no disconnected portion, and the transmitting portions 10 have a pattern shape in which patterns are apart from each other. Each transmitting portion 10 is formed into, for example, a rectangular shape, and sides of the portion are arranged in parallel with the first direction X and the second direction Y. A design aperture ratio can be adjusted by changing a side length of the transmitting portion 10 and, on the other hand, when the design aperture ratio is too high, the side length of the transmitting portion 10 becomes too long, and a formation line width of the reflecting portion 11 becomes too small.

In a regular screen printing process, to avoid unevenness in shape of the reflecting portion 11 and meet a necessary transmittance, using a screen mesh having 150 to 420 meshes is desirable. In this case, the unevenness in shape of the light width is increased in a region of the reflecting portion 11 where the formation line width is 100 to 200 μm, and a line itself cannot be formed in a region of the same where the formation line width is 100 μm or below.

Therefore, according to this embodiment, when the formation line width is 200 μm or below, an aperture pattern of the semi-transmissive reflection layer 4 is changed to a pattern shape in which a plurality of patterns (for example, a rectangular shape) are arranged, namely, the transmitting portions have an integral shape (matrix shape) having no disconnected portion and the reflecting portion 11 are separated from each other. As a result, it is possible to avoid influence of the unevenness caused by blur or bleeding of printing when forming a thin line and create the aperture pattern with less formation unevenness in regions with all aperture ratios.

FIG. 9 shows an aperture pattern of a semi-transmissive reflection layer 4 according to a seventh embodiment. The aperture pattern of the semi-transmissive reflection layer 4 has a first direction X and a second direction Y orthogonal to this first direction X, and it is a pattern that varies from a region with a low aperture ratio (0%) to a region with a high aperture ratio (100%) along the first direction. That is, an area ratio of a reflecting portion varies along the first direction. To avoid unevenness in a pattern switching portion 50, each of transmitting portions 10 and the reflecting portion 11 is formed into a polygonal shape, for example, a square shape or a rhomboidal shape, and respective diagonal directions are aligned in parallel with the second direction. In a region 48a where the area ratio of the reflecting portion 11 is higher than 50%, i.e., a region where a design aperture ratio falls below 50%, a pattern comprising the reflecting portions 11 is formed, respective corners are in contact with each other in the reflecting portions 11 adjacent to each other, and the transmitting portions 10 have a pattern arrangement shape in which they are separated from each other.

In a region 48b where the design area ratio of the reflecting portions 11 is not greater than 50%, i.e., a region having the high design aperture ratio, a pattern comprising the transmitting portions 10 is provided, respective corners are in contact with each other in the transmitting portions 10 adjacent to each other, and the reflecting portions 11 has a pattern arrangement shape that the respective portions are apart from each other. The pattern switching portion 50 is a point where the design aperture ratio is 50%, the pattern changes its size alone but does not change its shape in the vicinity of the pattern switching portion 50, and hence evenness in luminance can be eliminated in the switching portion 50. When a printing pattern in which the corner portions are in contact with each other is provided as described above, a thin line portion pattern that greatly varies can be prevented from being generated.

FIG. 10 shows an aperture pattern of a semi-transmissive reflection layer 4 according to an eighth embodiment. The aperture pattern of the semi-transmissive reflection layer 4 has a first direction X and a second direction Y orthogonal to this first direction X, and it is a pattern that varies from a region with a low aperture ratio (0%) to a region with a high aperture ratio (100%). That is, an area ratio of a reflecting portion 11 varies along the first direction.

Each of transmitting portions 10 and the reflecting portion 11 is formed into, for example, a rectangular shape, and each side is aligned in parallel with the first direction x or the second direction Y. The aperture pattern is a pattern comprising the transmitting portions 10 in a region 48a where the reflecting portion 11 has a high area ratio, an area of each transmitting portion 10 is increased as the area ratio of the reflecting portion 11 is decreased, and each transmitting portion 10 has line portions 10a connecting the adjacent transmitting portions with each other. These line portions 10a become thicker as the area ratio of each transmitting portion 10 is increased. In a region 48a having the reflecting portion area ratio where a width of each line portion 10a is not greater than a design minimum line width, each line portion 10a is disconnected.

That is, to avoid unevenness in luminance of a pattern switching portion 50, an arrangement pattern in which a slit (the line portion) is provided at an intermediate point of each side of the reflecting potion 11 is formed. The same pattern formation as that in the sixth embodiment shown in FIG. 8 is performed in the region 48a with the low design aperture ratio, and a side length of each transmitting portion 10 is not increased but the line portion 10a that cuts across the reflecting portion 11 is provided at the intermediate point of each side of the reflecting portion 11 in the region 48b where the width of the reflecting portion 11 falls below 200 μm. When the width of the line portion 10a is changed in accordance with an increase/decrease in the design aperture ratio, unevenness in luminance of the pattern switching portion 50 can be avoided.

In case of the aperture pattern according to this embodiment, a minimum width of the line portion 10a is set to, for example, 200 μm, and the side length of each transmitting portion 10 is sequentially increased in the region 48a where this line width is 0 to 200 μm, thereby avoiding formation of each line portion 10a. As a result, when forming the aperture pattern based on, for example, screen printing, even if a viscosity state of a print ink or printing conditions fluctuate, a pattern shape with less unevenness can be obtained, and an stable aperture ratio distribution can be obtained as designed.

Therefore, it is possible to obtain the formation pattern of the semi-transmissive reflection layer 4 which meets limitations of a resolution in an existing pattern formation process of screen printing and the like, in which unevenness in luminance is hardly visually recognized, and which is rarely affected by fluctuations in printing conditions.

It is to be noted that the lighting device having the light sources arranged on the plane has been described in the embodiments, but it is possible to adopt a planar illumination unit for one light source or a lighting device having a curved surface like an LED bulb.

A liquid crystal display device comprising the lighting device according to an embodiment will now be described.

FIG. 13 is an exploded perspective view showing the liquid crystal display device. According to this embodiment, the liquid crystal display device comprises a rectangular liquid crystal display panel 20 and a lighting device 12 which is arranged to face a back side of this liquid crystal display panel 20 and functions as a backlight unit. The liquid crystal display panel 20 comprises a rectangular array substrate, a rectangular opposed substrate arranged to face the array substrate to interpose a gap therebetween, and a liquid crystal layer hermetically put between the array substrate and the opposed substrate. The lighting device 12 is provided to be adjacent to and face the array substrate of the liquid crystal display panel 20.

The lighting device 12 comprises a lower-surface reflection layer 6 formed on an upper surface of a rectangular mount substrate 7, many point light sources 1 arranged on the mount substrate 7 in a two-dimensional matrix shape, a light guide plate 3 that is arranged above the point light sources 1 and fixed by non-illustrated support members and a housing, and a diffuser sheet or a diffuser panel 5 arranged between the light guide plate 3 and the liquid crystal display panel 20.

On a light extraction surface side of the light guide plate 3, a non-illustrated semi-transmissive reflection layer 4 is formed on an entire light extraction region. An aperture pattern of the semi-transmissive reflection layer 4 is associated with the arrangement of the point light sources 1, and it is formed in such a manner that a portion with a high incident light volume from each light source has a smaller aperture ratio than other portions. Besides, the lighting device is configured like the lighting device according to the foregoing embodiments.

According to the thus configured lighting device 12 and the liquid crystal display device comprising this lighting device 12, light emitted from each point light source 1 is temporarily propagated through the light guide plate 3 and eventually applied to the liquid crystal display panel 20 through the semi-transmissive reflection layer 4 and the diffuser sheet or the diffuser panel 5. After transmitted through the diffuser sheet or the diffuser panel 5, the light can have a uniform luminance distribution on the entire light extraction region.

With the above-described configuration, the lighting device having a reduced thickness, high efficiency, and high design freedom in a luminance distribution can be obtained. Further, the lighting device that can achieve both the reduction in thickness and energy saving can be obtained, the semi-transmissive reflection layer can be formed in a process with high productivity and the like, and it is possible to realize the lighting device in which a pattern of the semi-transmissive reflection layer is not directly visually confirmed as unevenness and unevenness hardly occurs by a viewing angle. At the same time, it is possible to obtain the lighting device superior in uniformity in luminance in a light-emitting region in local dimming driving. When this lighting device is applied to the liquid crystal display device, a high-quality large-screen liquid crystal display device that meets high contrast, low power consumption, and a reduction in thickness can be provided.

As the matrix arrangement of the point light sources 1, it is possible to adopt an arrangement in which the point light sources form one group and respective groups are aligned in a matrix form. However, when the single light source is arranged in a matrix form, a degree of unevenness in luminance is small with respect to positional deviations of the semi-transmissive reflection layer 4 and the point light source 1, which is a desirable configuration. Further, as the point light source, a white color or any other color can be applied, and a type of the point light source 1 is not restricted.

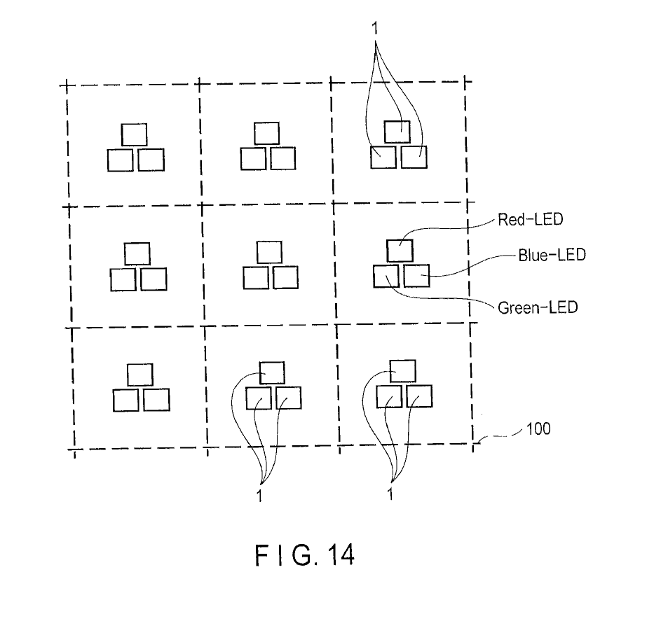

For example, as the lighting device for the liquid crystal display panel, a lighting device in which monochromatic LEDs are combined to create white light may be adopted. In this case, as shown in FIG. 14, three LEDs that emit red, blue, and green lights can be arranged side by side to form one group, and the groups may be arranged in a matrix shape. Furthermore, as a pattern of the semi-transmissive reflection layer 4, a region 100 having a cycle period is arranged to coincide with a boundary between matrix arrangement periods of the respective LED groups. As a result, it is possible to achieve the illumination having both uniform luminance and uniform chromaticity even though the polychromatic light sources are used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Although the lighting device as the backlight of the liquid crystal display device has been described in the embodiments, the lighting device according to the present invention can be also used as a lighting device for the purpose of illumination and others. The light source is not restricted to the point light source, and other light source such as a line light source can be used. Moreover, although the lighting device is configured to have one semi-transmissive reflection layer and one diffusion layer in the foregoing embodiments, the present invention is not restricted thereto, and semi-transmissive reflection layers may be provided in an overlapping manner or diffusion layers may be provided as required.

What is claimed is:

1. A lighting device comprising:
a light source; and a semi-transmissive reflection layer opposing the light source,
wherein the semi-transmissive reflection layer comprises a pattern comprising transmitting portions or reflecting portions, and
the pattern comprises a pattern formed of the transmitting portions each having a hole conformation in a region to which a high volume of light form the light source incident, and a pattern formed of the reflection portions each having a dot conformation in a region to which a low volume of light form the light source incident.

2. A lighting device comprising:
a light source; and a semi-transmissive reflection layer opposing the light source,
wherein the semi-transmissive reflection layer has a pattern comprising transmitting portions or reflecting portions, and
the pattern comprises a pattern formed of the transmitting portions in a region having a high area ratio of the reflecting portions, an area of the transmitting portions is increased as the area ratio of the reflecting portions is reduced, the transmitting portions comprises line portions configured to connect the transmitting portions adjacent to each other, the line portions become thicker as an area ratio of the transmitting portions is increased, and the line portions are disconnected in a region wherein the area ratio of the reflecting portions is not greater than a design minimum line width.

3. An lighting device comprising:
a light source; and a semi-transmissive reflection layer opposing the light source,
wherein the semi-transmissive reflection layer comprises a pattern comprising transmitting portions or reflecting portions, and
the pattern comprises a first direction and a second direction perpendicular to the first direction and an area ratio of the reflecting portions varies in the first direction, each of the transmitting portions and the reflecting portions is formed into a polygonal shape, respective diagonal directions are aligned in parallel with the second direction, and the pattern comprises a pattern formed of the transmitting portions in a region where a design area ratio of the reflecting portions is not smaller than 50%, and a pattern formed of the reflecting portions in a region where the area ratio of the reflecting portions is below 50%.

4. The device according to claim 1, wherein the light source comprises two-dimensionally arranged light sources.

5. The device according to claim 4, further comprising a diffusion layer outside the semi-transmissive reflection layer.

6. The device according to claim 2, wherein the light source comprises two-dimensionally arranged light sources.

7. The device according to claim 5, further comprising a diffusion layer outside the semi-transmissive reflection layer.

8. The device according to claim 3, wherein the light source comprises two-dimensionally arranged light sources.

9. The device according to claim 8, further comprising a diffusion layer outside the semi-transmissive reflection layer.

10. An lighting device comprising:
two-dimensionally arranged light sources;
at least one diffusion layer opposing the light sources; and
at least one semi-transmissive reflection layer arranged between the light sources and the diffusion layer,
wherein the semi-transmissive reflection layer which is the farthest from the light sources comprises a pattern comprising transmitting portions or reflecting portions, and a relationship of D≧P is met, where D is an interval between the semi-transmissive reflection layer and the diffusion layer which is the farthest from the light sources and P is a maximum arrangement interval in a pattern at which the transmitting portions or the reflecting portions are adjacent to each other in the semi-transmissive reflection layer which is the farthest from the light sources.

11. The device according to claim 10, wherein the pattern comprising the transmitting portions or the reflecting portions is configured by combining continuous pattern groups having fixed pattern intervals, and an aperture ratio distribution of each pattern group is controlled by changing a size of the transmitting portions or the reflecting portions in accordance with a forming position.

12. The device according to claim 10, wherein the pattern comprising the transmitting portions or the reflecting portions is configured by combining continuous pattern groups having different pattern intervals.

13. The device according to claim 12, wherein the pattern comprising the transmitting portions or the reflecting portions has a pitch and an aperture ratio designed in a polar coordinate system.

14. The device according to claim 12,
wherein, in the pattern comprising the transmitting portions or the reflecting portions, pattern intervals in a circumferential direction are formed at substantially fixed angles in a region where an aperture ratio is not smaller than 50%.

15. The device according to claim 10, wherein the pattern comprising the transmitting portions or the reflecting portions comprises a pattern formed of the transmitting portions in a region close to the light sources, and a pattern formed of the reflecting portions in a region far from the light sources.

16. The device according to claim 10, wherein PL<8×DL is met, where PL is the widest arrangement interval between the light sources, and DL is an interval between the semi-transmissive reflection layer which is the closest to the light source and the light source.

17. A liquid crystal display device comprising:
a liquid crystal display panel; and
an lighting device according to one of claim 1, arranged to face the liquid crystal display panel and configured to radiate the liquid crystal display panel with light.
